(19) United States
(12) Patent Application Publication
(10) Pub. No.: US 2026/0208519 A1
(43) Pub. Date: Jul. 23, 2026

(54) Braille Printing Device

(71) Applicant: Jack B. Martin, Oak Park, CA (US)

(72) Inventor: Jack B. Martin, Oak Park, CA (US)

(21) Appl. No.: 19/032,917

(22) Filed: Jan. 21, 2025

(51) Int. Cl. B41M 3/16

(52) U.S. Cl. CPC B41M 3/16

(57) ABSTRACT

A braille printing device includes a device body; a linear actuator with an actuator body and an actuator hammer; a liquid ejection unit, including a liquid container a piston assembly including a piston member with a conical bottom end and an o-ring that resides in a ring indentation with a tapered indentation, a lubrication canal system, a connection tube, and a tapering tube; and a control unit, such that the braille printing device ejects projectiles of ejected resin droplets, which are deposited as spherical domes of printing resin on a printing substrate to form a braille text.

### CROSS-REFERENCE TO RELATED APPLICATIONS

N/A.

### FIELD OF THE INVENTION

The present invention relates generally to the field of braille dot manufacturing, and more particularly to methods and systems for manufacturing braille dots on ADA (Americans with Disabilities Act) compliant signs.

### BACKGROUND OF THE INVENTION

Manufacturing of braille dots for ADA compliant signs according to conventional method requires use of complex systems and methods, that necessitate extensive training and are associated with a time-consuming manufacturing process.

Current common methods of manufacturing braille dots include:

a) Raster type braille, which is done using complicated machinery to drill and force small acrylic spheres into the newly drill hole only halfway, thereby leaving half of the sphere above the surface resulting in a raised bump, which forms a braille dot;

b) Photopolymer braille, which is the most complicated method, involving creation of a photo negative, which is used as a mask for ultraviolet light exposure on to a special light sensitive plate. After exposing, the uncured areas are removed leaving only the raised areas to produce the braille dots; and

c) Resin deposition braille, which allows resin droplets to be deposited on a surface to enable writing of braille text.

However, current available methods and systems for resin deposition require a printer head to move in close adjacency to printing surface, such that a resin droplet can be deposited by contact transfer. This requires close vertical control of the printer head, which requires complex mechanical machinery and causes risk of damage to the printing equipment.

As such, considering the foregoing, it may be appreciated that there continues to be a need for novel and improved devices and methods for printing braille text.

### SUMMARY OF THE INVENTION

The foregoing needs are met, to a great extent, by the present invention, wherein in aspects of this invention, enhancements are provided to the existing model of printing of braille text.

In an aspect, a braille printing device can include:

a) a device body, which is connected to moveable portion of an engraving machine, such that the device body is configured to be longitudinally and laterally moveable, by a corresponding movement of the moveable portion of the engraving machine;

b) a linear actuator, which can include:

i. an actuator body, which can be connected to the device body; and

ii. an actuator hammer, which is vertically slidable, relative to the actuator body;

c) a liquid ejection unit, which is connected to the device body, such that an ejection aperture of the liquid ejection unit is configured to point downward, such that the liquid ejection unit is configured to inject liquid drops of a printing fluid on the printing panel, wherein the liquid ejection unit can include:

i. a liquid container, which can include an upper opening into a container interior, which can be filled with a liquid resin;

ii. a piston assembly, which can include:

a piston member, such that a lower end of the piston member can be configured with a conical portion;

wherein the piston assembly penetrates into the container interior, such that the piston member of the piston assembly seals walls of the container interior, and such that downward pressure on the piston assembly pressurizes the liquid resin in the container interior; and

iii. a tapering tube, which is hollow, such that an upper end of the tapering tube is in fluid connection with the liquid container, wherein a lower end of the tapering tube includes an ejection aperture;

d) a control unit, which can be configured to control the liquid ejection unit, such that the control unit;

such that when the actuator hammer strikes the upper part of the piston member, this causes the lower part of the piston assembly to impact with the liquid resin, such that the lower part of the piston assembly causes a shockwave to travel through the liquid resin, such that the shockwave causes ejection of an ejected resin droplet from the ejection aperture, such that the ejected resin droplet is ejected downwards from the ejection aperture;

such that the ejected resin droplet impacts with a printing substrate surface below the tapering tube, such that the ejected resin droplet forms a braille dot on the surface of the printing substrate;

such that the control unit controls the liquid ejection unit, such that the liquid ejection unit can deposit spherical domes/dots of the liquid resin on an exposed surface of the printing substrate, such that the spherical domes form a braille text of raised braille elements.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1A is a top front perspective view of a braille printing device, according to an embodiment of the invention.

FIG. 1B is a bottom front perspective view of a braille printing device, according to an embodiment of the invention.

FIG. 1C is a rear bottom perspective view of a braille printing device, according to an embodiment of the invention.

FIG. 1D is a rear side view of a braille printing device, according to an embodiment of the invention.

FIG. 1E is a top side view of a braille printing device, according to an embodiment of the invention.

FIG. 1F is a bottom side view of a braille printing device, according to an embodiment of the invention.

FIG. 1G is a cross-sectional view of a braille printing device taken along section line 1G-1G of FIG. 1E, according to an embodiment of the invention.

FIG. 2A is a schematic diagram of a braille printing device during a first step of operation, according to an embodiment of the invention.

FIG. 2B is a schematic diagram of a braille printing device during a second step of operation, according to an embodiment of the invention.

FIG. 2C is a schematic diagram of a braille printing device during a third step of operation, according to an embodiment of the invention.

FIG. 2D is a schematic diagram of a braille printing device during a fourth step of operation, according to an embodiment of the invention.

FIG. 3A is a bottom front perspective view of a liquid ejection unit of a braille printing device, according to an embodiment of the invention.

FIG. 3B is a top front perspective view of a liquid ejection unit of a braille printing device, according to an embodiment of the invention.

FIG. 3C is a cross-sectional view of a liquid ejection unit of a braille printing device taken along section line 3C-3C of FIG. 1F, according to an embodiment of the invention.

FIG. 3D is a cross-sectional view of a portion of a liquid ejection unit of a braille printing device taken along section line 3C-3C of FIG. 1F, according to an embodiment of the invention.

FIG. 3E is a top perspective exploded view of parts of a liquid ejection unit of a braille printing device, according to an embodiment of the invention.

FIG. 3F is a bottom perspective exploded view of parts of a liquid ejection unit of a braille printing device, according to an embodiment of the invention.

FIG. 3G is a side view of a piston member of a liquid ejection unit of a braille printing device, according to an embodiment of the invention.

FIG. 3H is a bottom perspective view of a piston member of a liquid ejection unit of a braille printing device, according to an embodiment of the invention.

FIG. 3I is a top perspective view of a piston member of a liquid ejection unit of a braille printing device, according to an embodiment of the invention.

FIG. 4 is a front top perspective view of a braille printing system, according to an embodiment of the invention.

FIG. 5 is a side cross-sectional view of a braille printing system, according to an embodiment of the invention.

FIG. 6 is a schematic diagram illustrating a control unit for a braille printing device, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

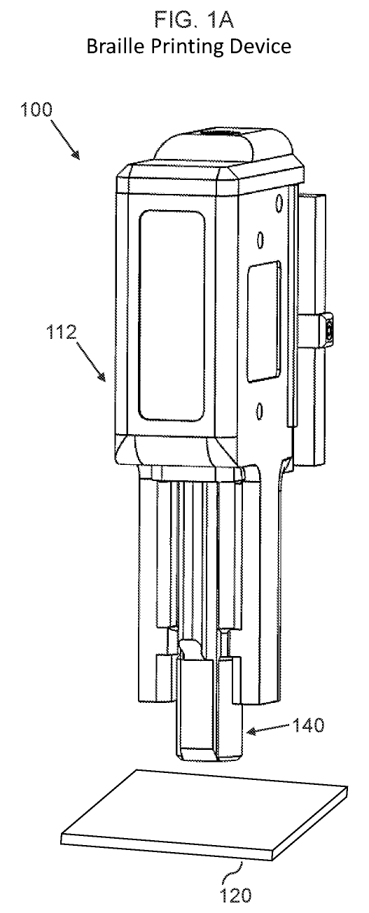

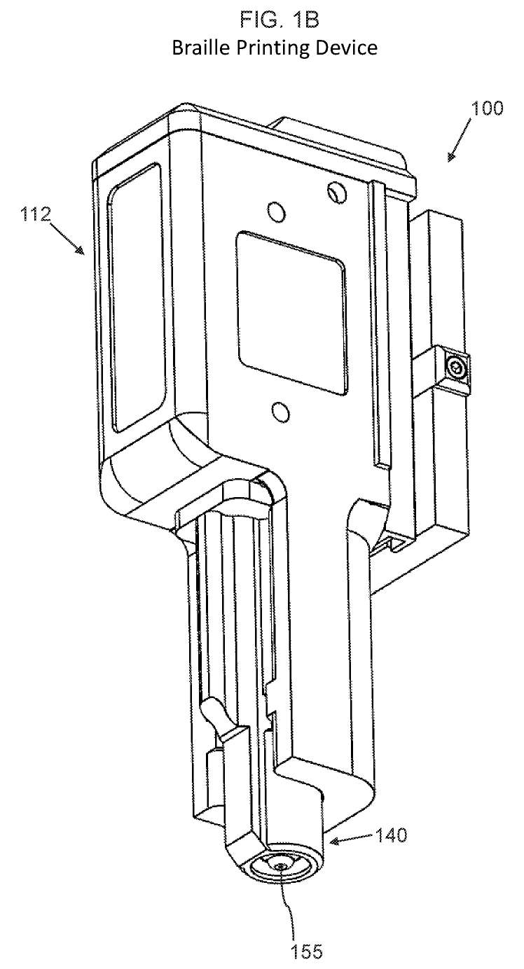

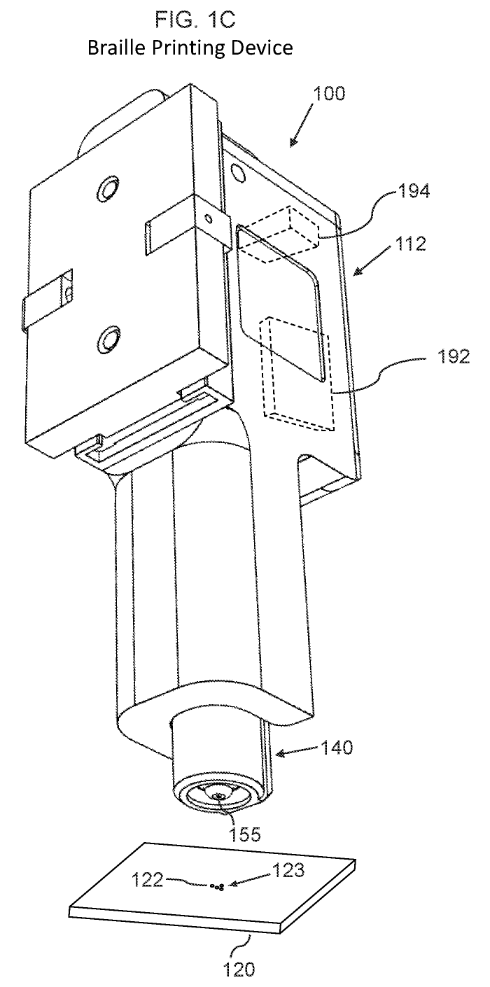

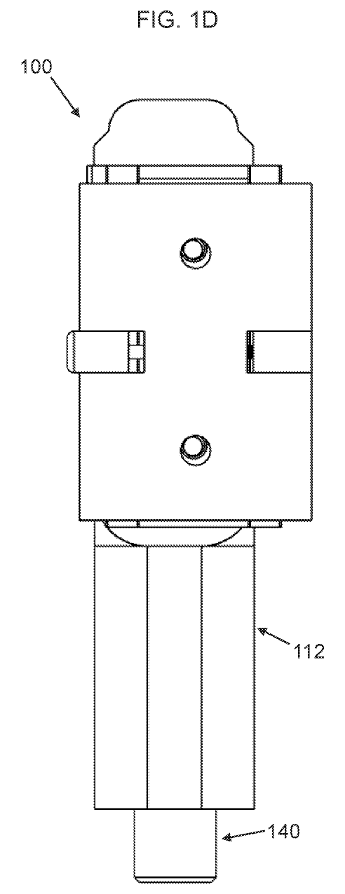

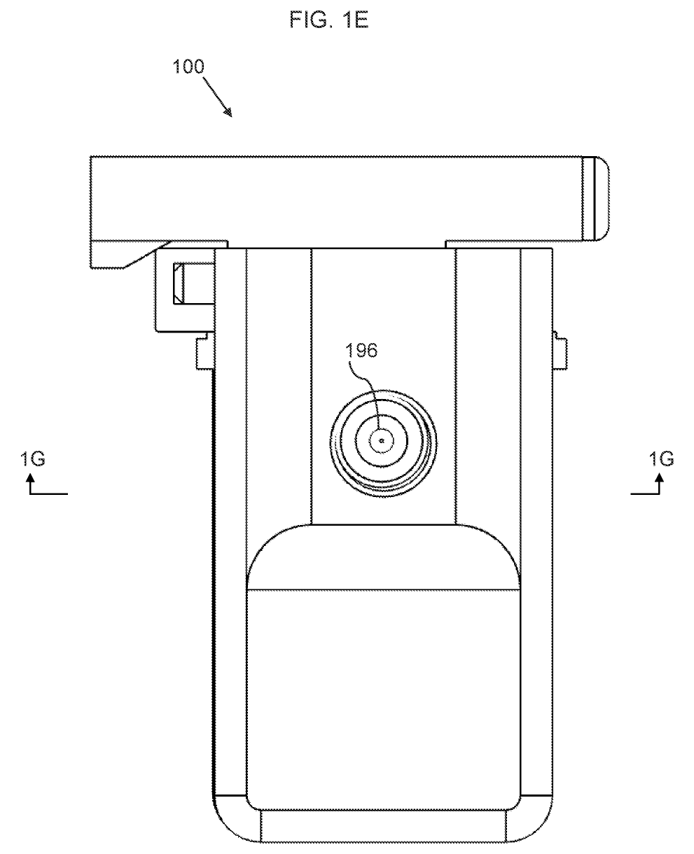

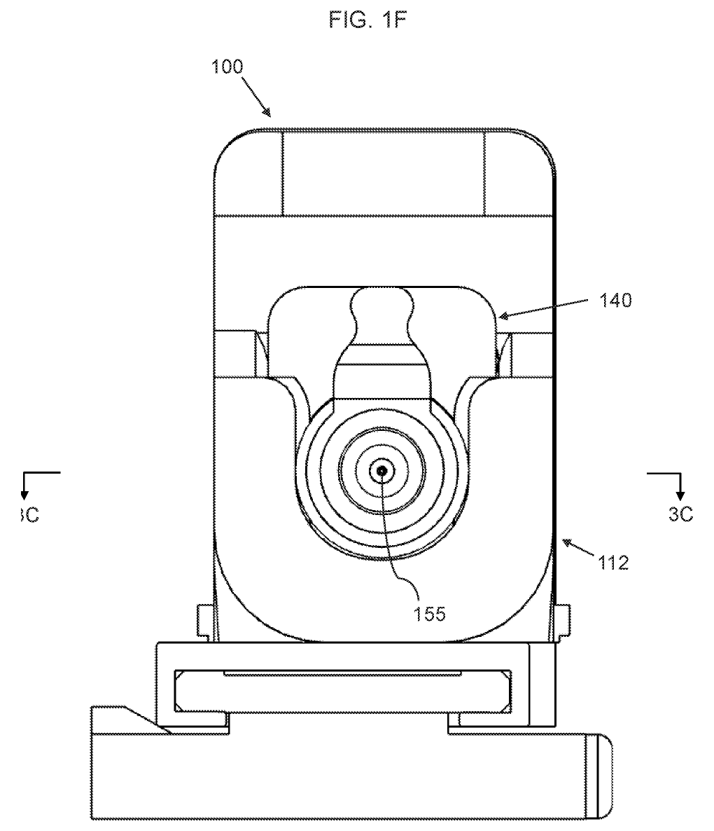

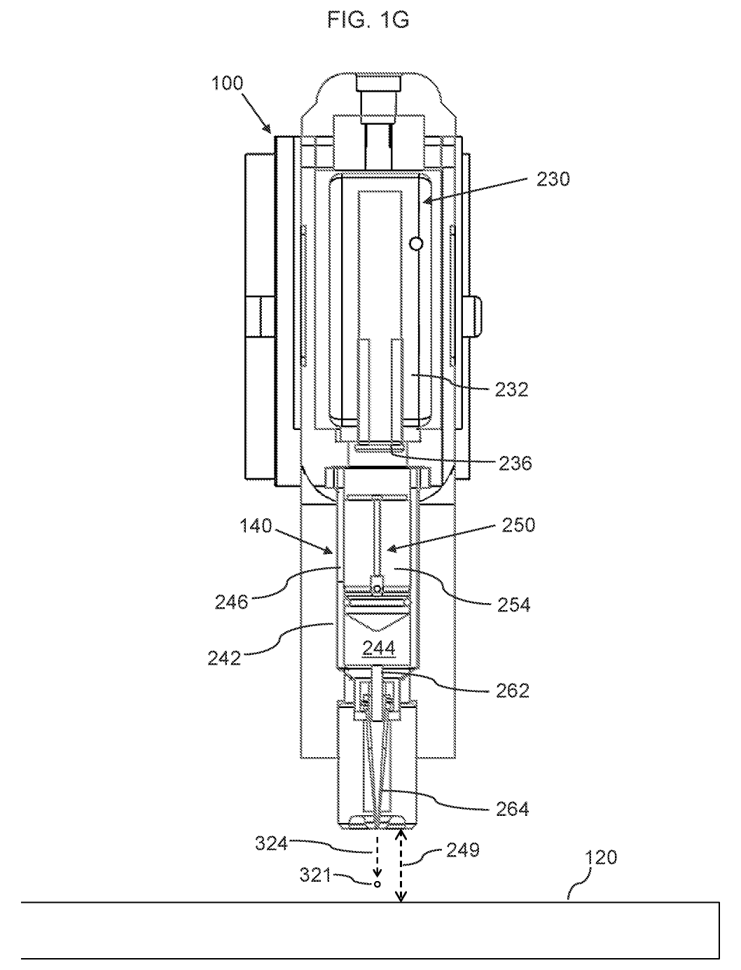

In the following, we describe the structure of an embodiment of a braille printing device 100 with reference to FIG. 1A, in such manner that like reference numerals refer to like components throughout; a convention that we shall employ for the remainder of this specification.

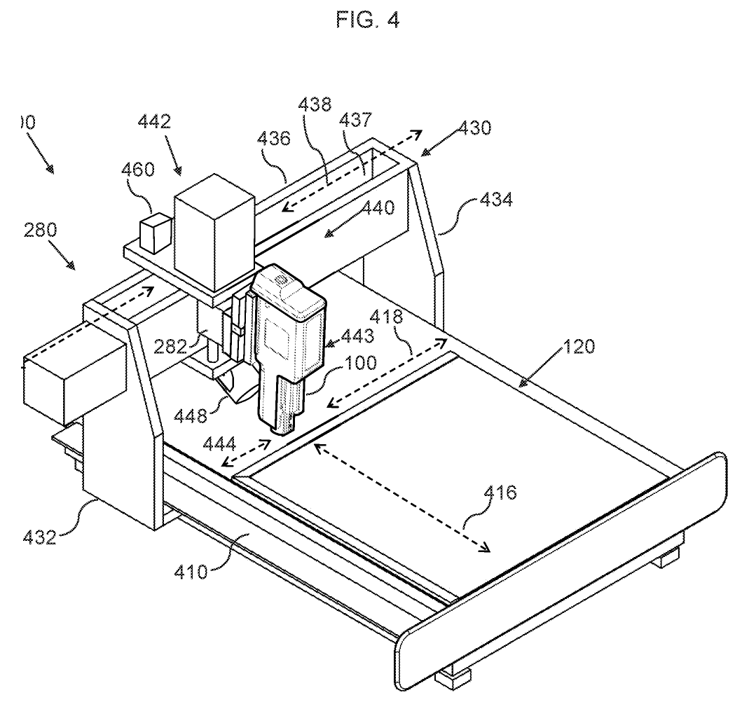

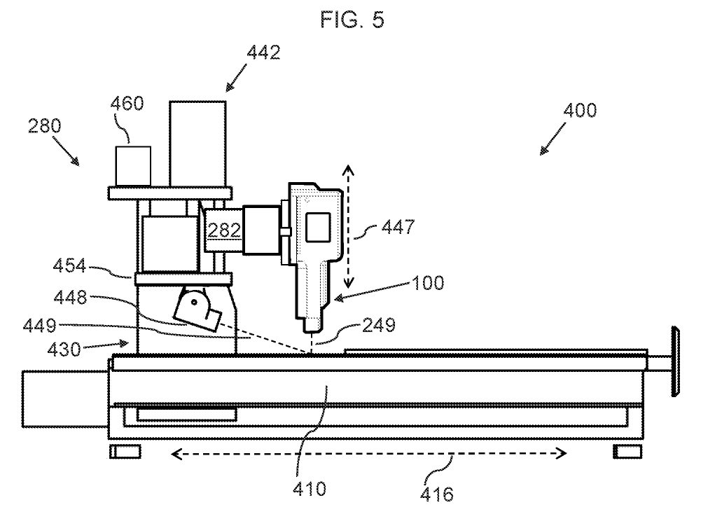

In various related embodiments, as shown in FIGS. 4 and 5, the braille printing device 100 attaches to an existing engraving machine 280. A control unit sends an electrical pulse to a striker motor, which causes an actuator hammer to strike a piston assembly, which impacts with a liquid resin in a resin chamber. This striking operation causes a shockwave to travel thru the resin chamber resulting in a metered amount of UV curable resin to be discharged as a liquid projectile at the ejection aperture 155, such that the droplet of resin is deposited on a surface of the printing substrate. After all of the resin braille dots have been discharged, a UV light source (which can be handheld) can be used to fully cure the resin dots. Thus, the configuration of the braille printing device 100, and associated method of use, avoids the need of earlier devices and systems to adjust a vertical distance to the printing substrate in order to deposit a liquid drop via contract transfer, by instead ejecting an ejected resin droplet 321 as a liquid projectile.

Thus, in an embodiment, as shown in FIGS. 1A - 1G, 3A - 3I, 4, and 5, a braille printing device 100 can include:

a) a device body 112, which is configured to be detachably connected to a moveable portion 282 of an engraving machine 280, such that the device body 112 is configured to be longitudinally 416 and laterally 418 moveable (and optionally vertically 447 moveable), by a corresponding movement of the moveable portion 282 of the engraving machine 280, as shown in FIGS. 4 and 5;

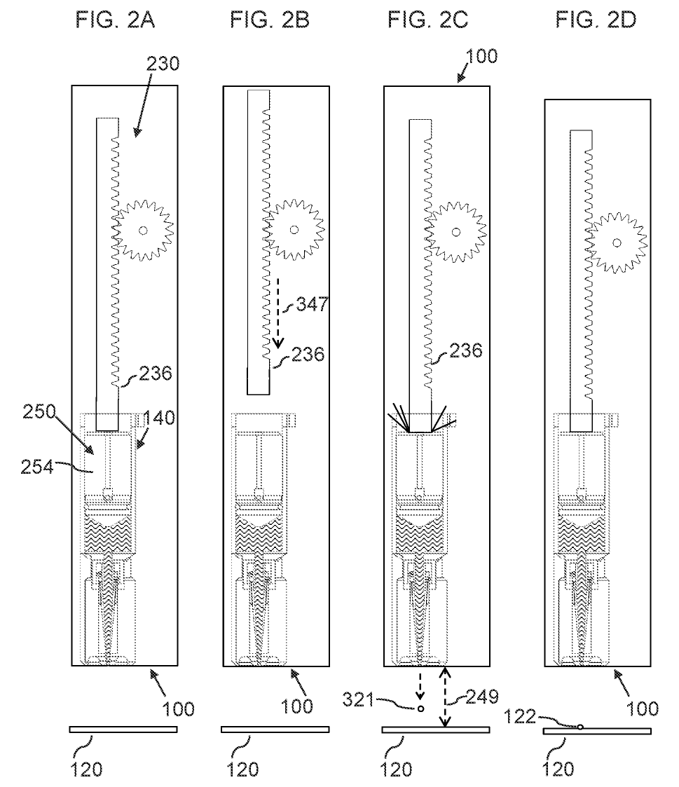

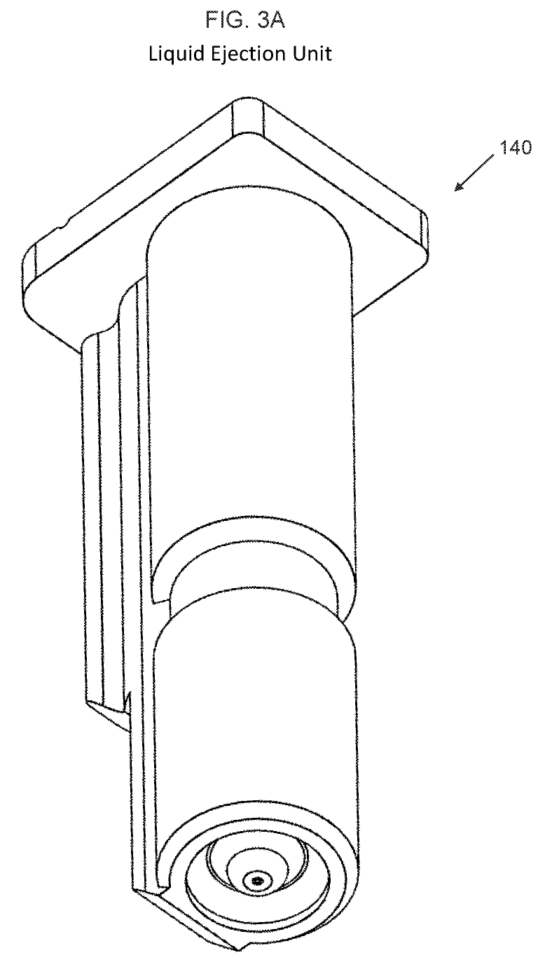

b) a linear actuator 230, as shown in FIGS. 1G and 2A, which can include:

i. an actuator body 232, which can be connected to the device body; and

ii. an actuator hammer 236, which is configured to be vertically slidable, relative to the actuator body 232;

c) a liquid ejection unit 140, which is connected to the device body 112, such that an ejection aperture 155 of the liquid ejection unit 140 is configured to point downward, such that the liquid ejection unit 140 is configured to eject liquid drops 321 of a liquid resin 248 on a printing substrate 120, wherein the liquid ejection unit 140 can include:

i. a liquid container 242, which comprises an upper opening 243 into a container interior 244, which can contain (i.e. contains) a liquid resin 248;

ii. a piston assembly 250, which comprises:

a piston member 254, which is at least partially inserted into the liquid container 242;

wherein the piston assembly 250 penetrates into the container interior 244, such that the piston member 254 of the piston assembly 250 seals walls 246 of the container interior 244, and such that downward pressure on the piston assembly 250 pressurizes the liquid resin 248 in the container interior; and

iii. a tapering tube 264, which is hollow, such that an upper end of the tapering tube 264 is in fluid connection with the liquid container 242, wherein a lower end of the tapering tube 264 includes an ejection aperture 155, which is in fluid contact with the liquid container 242, , wherein the tapering tube 264 can be configured with a conical shape with a downward diminishing interior diameter, such that the downward diminishing interior diameter of the tapering tube 264 increases a speed of the liquid resin, such that a surface tension of the liquid resin 248 is overcome, to enable release of an ejected resin droplet;

d) a control unit 192, which can be configured to control the liquid ejection unit 140, such that the control unit 192 for example as shown can be mounted on the device body 112;

such that when the actuator hammer 236 strikes the upper part 352 of the piston member 254, this causes the lower part 254 of the piston assembly 250 to impact with the liquid resin 248, such that the lower part 254 of the piston assembly 250 causes an initial shockwave 392 to travel through the liquid resin 248, such that the shockwave 392 pushes out an ejected resin droplet 321 from the ejection aperture 155 (of the tapering tube 264), such that the ejected resin droplet 321 is ejected downwards from the ejection aperture 155 (and from the tapering tube 264);

such that the ejected resin droplet 321 impacts with a surface of a printing substrate 120 below the tapering tube 264, such that the ejected resin droplet 321 forms a braille dot 122 on the surface of the printing substrate 120;

such that the control unit 192 can be configured to control the liquid ejection unit 140, such that the liquid ejection unit 140 can deposit spherical domes/dots 122 of the liquid resin 248 on an exposed surface of the printing substrate 120, such that the spherical domes 122 form a braille text 123 of raised braille elements.

In a related embodiment, the braille printing device 100 can further include:

a) a connection tube 262, which is hollow, such that an upper end of the connection tube 262 is in fluid connection with the liquid container 242 and a lower end of the connection tube 262 is in fluid connection with the upper end of the tapering tube 264, such that the connection tube 262 stabilizes the concentrated shockwave 398 before the concentrated shockwave 398 enters the tapering tube 264.

In a further related embodiment, a lower end of the piston member 254 can be configured with a conical portion 358, such that at least a bounced portion 394 of the initial shockwave 392 will be directed outwards and downwards, such that the bounced portion 394 of the initial shockwave bounces off inner sides of the liquid container, such that a concentrated shockwave 398 is concentrated in a lower longitudinal center of the liquid container.

In a yet further related embodiment, a lower center of the lower end of the piston member 254 can be further configured with a flat circular portion 359 that is connected around a lower end of the conical portion 358, such that the flat circular portion 359 is perpendicular to an elongated central axis 357 of the piston member 254, such that a central portion 396 of the initial shockwave 392 will be directed downwards, such that the bounced portion 394 of the initial shockwave 392 and the central portion 396 of the initial shockwave 392 merge in the lower longitudinal center of the liquid container to form the concentrated shockwave 398.

a) a tapered indentation 374, which tapers inward in a downward direction from the outer surface of the piston member 254 above the ring indentation; and

b) a main ring portion 376, such that an upper end (i.e., upper edge or upper circumference) of the main ring portion can be connected with a lower end (i.e., lower edge or lower circumference) of the tapered indentation;

such that the O-ring 356 will be pressed against the tapered indentation 374 when the piston assembly 250 is moving downward, such that the O-ring 356 expands, whereby a sealing of the piston assembly 250 is tightened; and

such that the O-ring 356 will be released from the tapered indentation when the piston assembly 250 is moving upward, such that the O-ring 356 expands, whereby a sealing of the piston assembly 250 is released.

In a further related embodiment, the tapered indentation 374 can be a conical segment, which can be configured with a uniform tapering angle 378 of 32 degrees, or in a range of 30 – 34, 28 – 36, 24 – 40, or 19 – 45 degrees.

In related embodiments, the tapered indentation 374 can resolve a problem wherein the resin does not meter correctly because the piston’s O-ring 356 sticks against the tube wall of the liquid container 242. When the piston member 254 is struck, it moves downward a very small amount. Afterward, the piston member 254 must move upward slightly to ensure there is zero pressure on the liquid resin 248. Otherwise, the resin 248 will slowly ooze out in small amounts. What is needed is a sealing action during the downward motion, but afterward, the O-ring 356 should stop contacting the tube wall to eliminate any drag on the piston member 254. The solution to this issue is the disclosed design, wherein the fit of the piston member’s 254 O-ring 356 groove is configured such that its slight contact with the tube wall creates enough drag during the downward movement. This drag will cause the O-ring 356 to expand as it presses against the 32-degree taper of the tapered indentation 374. As the piston member 254 moves downward, the O-ring 356 tightens its seal and then releases its pressure against the wall, eliminating drag and freeing the piston. This adjustment reduces the resin pressure to almost zero.

In another related embodiment, the piston assembly 250 can further comprise an O-ring 356, and the piston member 254 can further be configured with a ring indentation 370, which encircles an outer surface of the piston member 254, such that the O-ring 356 can be mounted in the ring indentation 370, such that the O-ring 356 is configured to prevent leakage of the liquid resin 248;wherein the piston member 254 van further be configured with a lubrication canal system 380, which projects into the piston member 254 from an upper canal opening 382 wherein the lubrication canal system 380 can include:

a) an upper central vertical canal 384, which projects into the piston member 254; and

b) at least one side canal 386a, 386b, 386c, 386c, such that an inner end of the at least one side canal 386a, 386b, 386c, 386c is connected to a lower end of the upper central vertical canal 384, and such that an outer end of the upper central vertical canal 384 is in fluid contact with the ring indentation 370;

such that the lubrication canal system is configured to deliver a lubrication liquid 388 from the upper canal opening 382 to the ring indentation 370, to lubricate the O-ring 356.

In a further related embodiment, the lubrication liquid 388 can be injected into the lubrication canal system 380 via the upper canal opening 382 during manufacturing of the liquid ejection unit 140 of the braille printing device 100. In some uses cases, the liquid ejection unit 140 may be discarded once the liquid ejection unit 140 is depleted of the liquid resin 248, and therefore there may not be a need to refill the lubrication canal system 380 with lubrication liquid 388 during normal use.

In a yet further related embodiment, the at least one side canal 386a, 386b, 386c, 386c can include four side canals 386a, 386b, 386c, 386c, which are uniformly positioned to project from the lower end of the upper central vertical canal 384 to right, left, front, and rear sides of the piston member 254.

In yet another related embodiment, the ring indentation 370 can include:

a) a top ring portion 372, such that the outer end of the at least one side canal 386a, 386b, 386c, 386c is in fluid contact with the top ring portion 372, such that the top ring portion 372 enables a flow of the lubrication liquid 388 around the top ring portion 372 above the O-ring 356;

b) a tapered indentation 374, such that a lower end of the top ring portion is connected with an upper end of the tapered indentation 374, which tapers inward in a downward direction from the outer surface of the piston member above the ring indentation 370; and

c) a main ring portion 376, such that an upper end of the main ring portion 376 is connected with a lower end of the tapered indentation 374;

such that the O-ring 356 will be pressed against the tapered indentation when the piston assembly 250 is moving downward, such that the O-ring 356 expands, whereby a sealing of the piston assembly 250 is tightened; and

such that the O-ring 356 will be released from the tapered indentation when the piston assembly 250 is moving upward, such that the O-ring 356 expands, whereby a sealing of the piston assembly 250 is released.

In a related embodiment, the braille printing device 100 can further include:

a) a battery pack 194, which powers electric components of the braille printing device 100, such as the control unit 192 and the linear actuator 230; and

b) a power plug 196, which can be configured to charge the battery pack 194, and can power the electric components of the braille printing device 100.

In an embodiment, as shown in FIGS. 2A, 2B, 2C, and 2D, a manufacturing sequence of using the braille printing device 100 can include:

a) Slowly lowering the actuator hammer 236, as shown in FIG. 2A, until the actuator hammer 236 contacts with the piston member 254 of the piston assembly 250;

b) Raising the actuator hammer 236 (using micro motor pulses at millisecond intervals), as shown in FIG. 2B, to bring the actuator hammer 236 to a predetermined height from the piston member 254 of the piston assembly 250;

Rapidly moving the actuator hammer 236 downward (using micro motor pulses at millisecond intervals), as shown in FIG. 2C, to strike the piston member 254 of the piston assembly 250 causes a shockwave 392 to travel through the liquid resin 248, such that the shockwave 392 ejects an ejected resin droplet 321 from the tapering tube 264, such that the ejected resin droplet 321 is ejected downwards from the ejection aperture. An outer surface of the tapering tube 264 can be coated with a low friction coating, such as a TEFLON (TM) coating, i.e. a coating that is made from or includes polytetrafluoroethylene, such that the ejected resin droplet 321 is ejected downwards from the ejection aperture 155 (and from the tapering tube 264) , such that the ejected resin droplet 321 impacts with the printing substrate 120, such that the ejected droplet 321 forms a braille dot 122, as shown in FIG. 2D;

c) Exposing the ejected resin droplet to ultraviolet light, such that the ejected resin droplet is cured and hardened, for example by using a handheld ultraviolet light source.

In some embodiments, the device body 112 can be configured to be vertically 447 (i.e., altitudinally) moveable, for example in order to clear obstacles and subsequently adjust to a suitable printing distance 249 to the printing substrate 120.

In a related embodiment, as shown in FIGS. 4 and 5, the braille printing device 100 can be a part of a braille printing system 400, which can also be referred to as a sign manufacturing system 400, which can include:

a) a printing base 410;

b) a printing panel 120, which can be removably positioned on a top surface of the printing base 410;

c) a bridge component 430, which can be slidably connected to the printing base 410, the bridge component 430 including:

i. a right flange 432, which is slidably connected to a right side of the printing base 410, such that the right flange 432 protrudes upward from the printing base 410;

ii. a left flange 434, which is slidably connected to a left side of the printing base 410, such that the left flange 434 protrudes upward from the printing base 410;

iii. a bridge connector 436, including a sliding cavity 437, such that the bridge connector 436 is connected between the right and left flanges 432 434;

such that the bridge component 430 (and thereby the bridge connector 436) can be configured to slide 416 along a longitudinal direction 416 relative to the printing base 410;

d) a sliding assembly 440, which can include: i. an assembly body 442, which is slidably connected to the bridge connector 436, such that the sliding assembly 440 is configured to slide along a lateral direction 418 relative to the printing base 410 (corresponding to a longitudinal direction 438 of the bridge connector 436); ii. A cutting/ejection assembly 443, which can also be referred to as a cutting and ejection assembly 443, including:

i. an assembly body 442, which is slidably connected to the bridge connector 436, such that the sliding assembly 440 is configured to slide along a lateral direction 418 relative to the printing base 410 (corresponding to a longitudinal direction 438 of the bridge connector 436);

ii. A cutting/ejection assembly 443, which can also be referred to as a cutting and ejection assembly 443, including:

a cutting laser 444, which is connected to the assembly body 442, such that a cutting laser beam 449 emitted from the cutting laser 444 is configured to point downward and impact (i.e. hit) the printing panel 120 that is positioned on a top surface of the printing base 110; and

a braille printing device 100, which is connected to the assembly body 442, such that an ejection aperture 155 of the braille printing device 100 is configured to point downward, such that the braille printing device 100 is configured to eject liquid drops 122 of a printing fluid 248 onto the printing panel 120;

iii. a curing laser 448, as shown in FIGS. 4 and 5, which is slidably connected to the bridge connector 436, such that the curing laser 448 is configured to slide along the lateral direction 418 of the printing base 410; and

e) a control unit 460, which is configured to control the sliding motions of the bridge component 430 in the longitudinal direction 416 and of the assembly body 442 in the lateral direction 418, such that the control unit 460 for example as shown can be mounted on the assembly body 442;

such that the control unit 460 can be configured to control the sliding motion of the sliding assembly 440, such that the braille printing device 100 can deposit spherical domes/dots 122 of the printing fluid on an exposed surface of the printing panel 120, such that the spherical domes 122 form a braille text 123 of raised braille elements; such that a curing laser beam emitted from the curing laser 448 can be pointed at the spherical domes 122 in order to cure and harden the spherical domes 122.

Thus, in various related embodiments, the braille printing device 100 employs a small shockwave caused by the mechanical striking of a piston member 254 with a conical head. The piston member 254 head mounted inside of a cylinder in turn forces resin from the outer regions to the center, which focuses down to a tapering tube 264, which terminates at a very small diameter. This results in a droplet 321 of very high viscosity resin being ejected like a liquid projectile. This cartridge design is used in a printer for the purpose of generating Braille dots on signage for the vision impaired. The conical shape of the front end of the piston member 254 causes the shockwave 392 to bounce of sidewalls of the cylinder and move inward, thereby causing velocity to increase, wherein the shockwave 392 is lead into a tapering tube 264 that has a progressively diminishing diameter, thus further increasing resin speed to the point when resin leaving the tip overcomes surface tension and creates a small projectile of resin.

In a related embodiment, as shown in FIGS. 4 and 5, the cutting/ejection assembly 443 can be slidably connected to the assembly body 442 (and thereby to the bridge component 430), such that the sliding assembly 440 can be configured to enable the cutting/ejection assembly 443 to slide altitudinally 447 (i.e. up and down/vertically 447), to adjust a vertical printing distance 249 between an ejection aperture 155 of the braille printing device 100 and the printing panel 120. The vertical printing distance 249 is shown exaggerated from a typical vertical printing distance 249 in FIG. 1G, for illustrative purposes. FIGS. 4 and 5 show typical vertical printing distances 249 during use. In some related embodiments, the sliding assembly 440 can be configured to enable solely the braille printing device 100 to slide vertically 447 (i.e. up and down/altitudinal 447), to adjust a vertical printing distance 249 between an ejection aperture 155 of the braille printing device 100 and the printing panel 120.

In a further related embodiment, the vertical printing distance 249 between an ejection aperture 155 of the braille printing device 100 and the printing panel 120 can be set to 3 mm or in a range of 2 – 6 mm or larger. In typical embodiments, the braille printing system 400 can be configured such that the ejected resin droplet 321 follows a flight trajectory 324 that is perpendicular to the surface of the printing substrate 120, but the braille printing system 400 can also be configured such that the ejected resin droplet 321 impacts with the printing substrate 120 at an angle, for example to print under a partial overhang.

Thus, in related embodiments, as shown in FIGS. 4 and 5, the braille printing system 400 can be understood to include an engraving machine 280 (which can also be called a printing machine), which includes a moveable portion 282 as a part of the assembly body 442 of the sliding assembly 440, wherein the braille printing device 100 is connected to the moveable portion 282, as shown in FIGS. 4 and 5.

In a related embodiment, the printing fluid/resin 248 can be an optically sensitive resin, which can be configured to cure when exposed to ultraviolet light, such as optically sensitive resins used as dental adhesives or adhesives for industrial use, including resin/adhesive compositions of N,N-Dimethylacrylamide, Isobornyl Acrylate, at least one photo-initiator, a silane coupling agent, and combinations thereof.

In another related embodiment, the curing laser 448 can be configured such that the curing laser beam 449 has a wavelength of approximately 405 nm or is in a range of 403 - 407 nm, 400 - 410 nm, or a wider range.

In another related embodiment, the curing laser 448 can be configured such that the curing laser beam 449 can have a power output of approximately/substantially 20 mW, or be in a range of 5 - 40 mW, 10 – 40 mw, 5 - 100 mW, 20 – 500 mW, or a wider range.

a) A processor 602;

b) A non-transitory memory 604;

c) An input/output 606; and

d) An ejection controller 610, which is configured to:

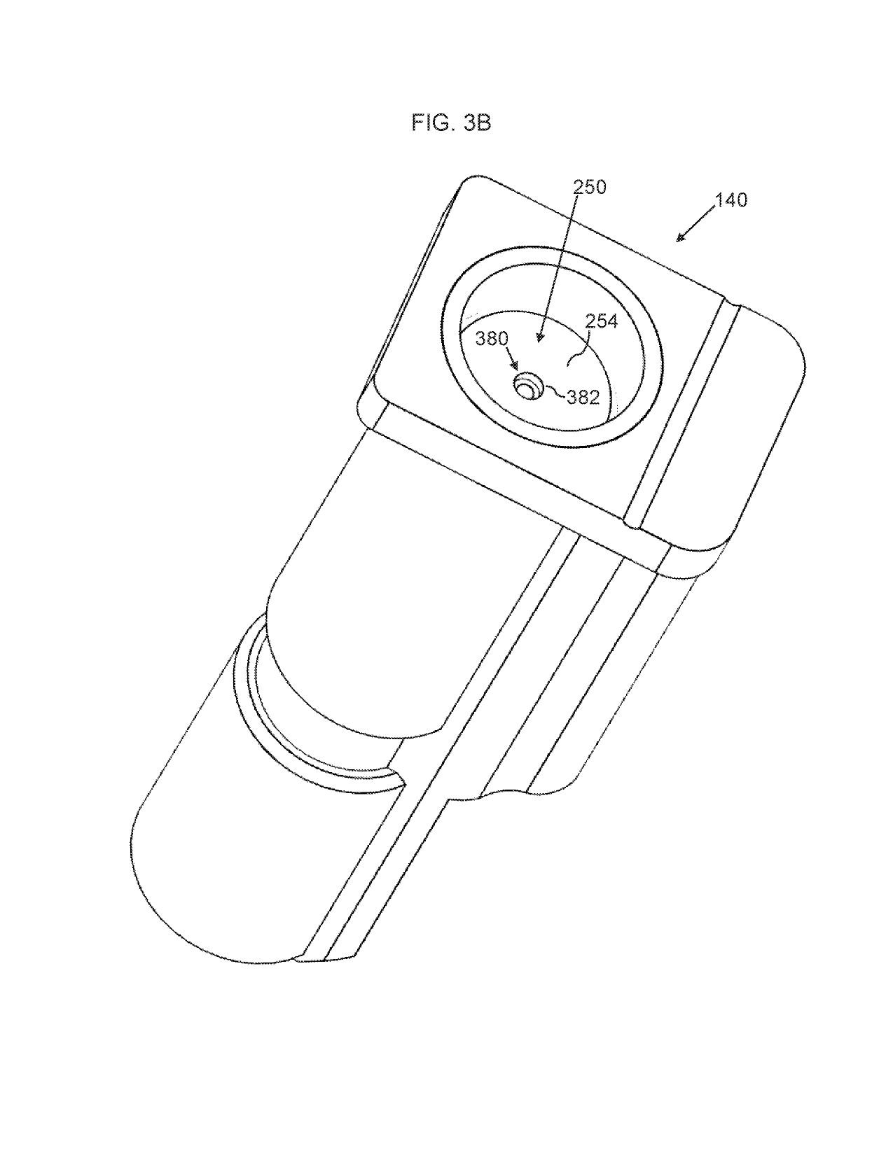

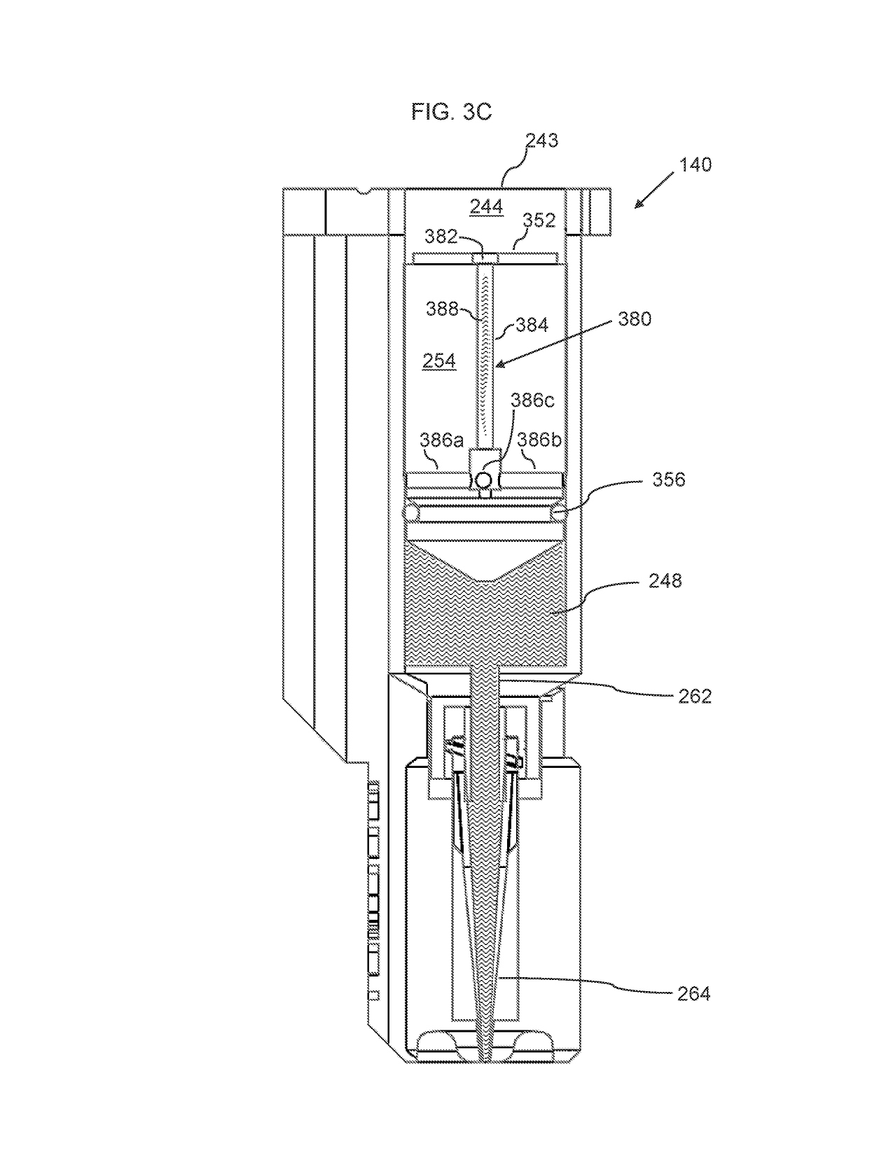

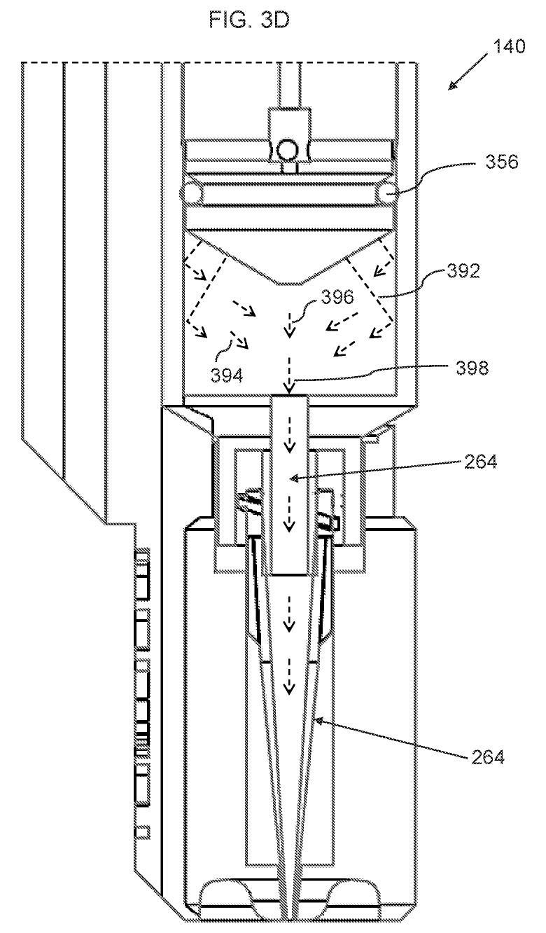

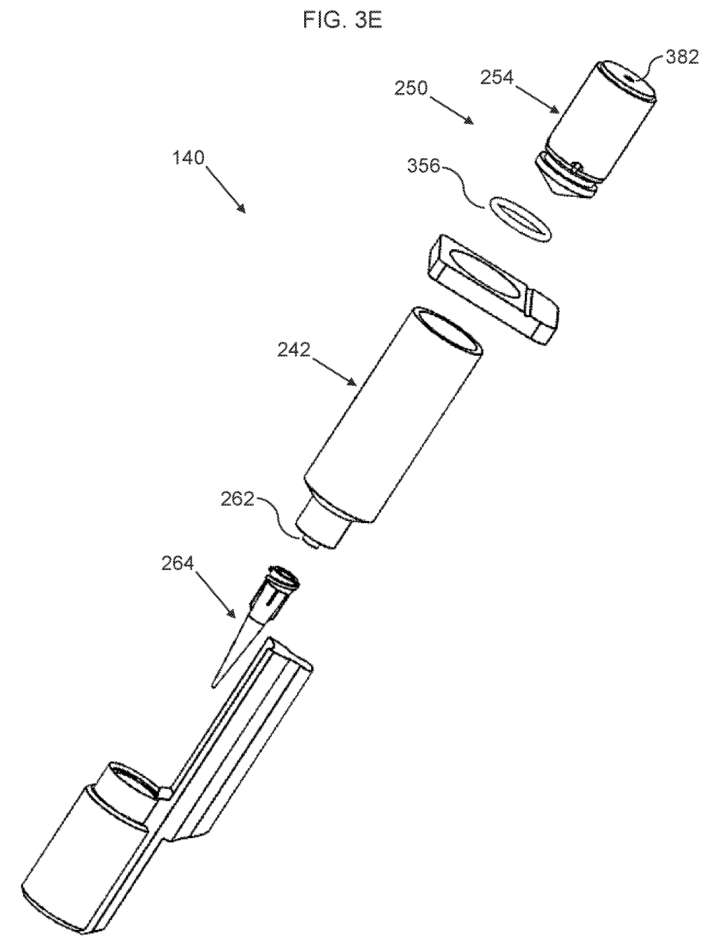

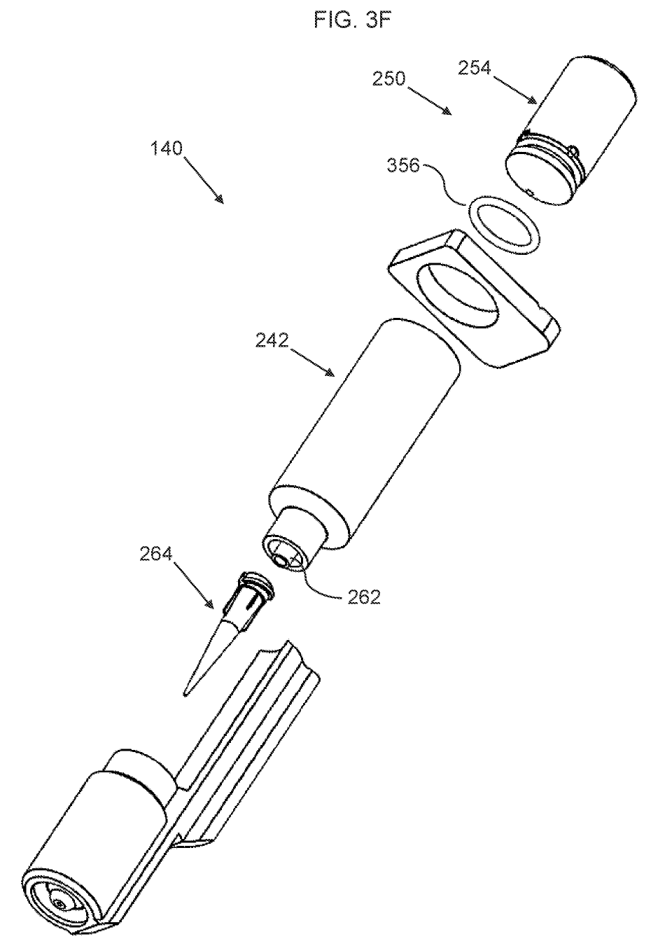

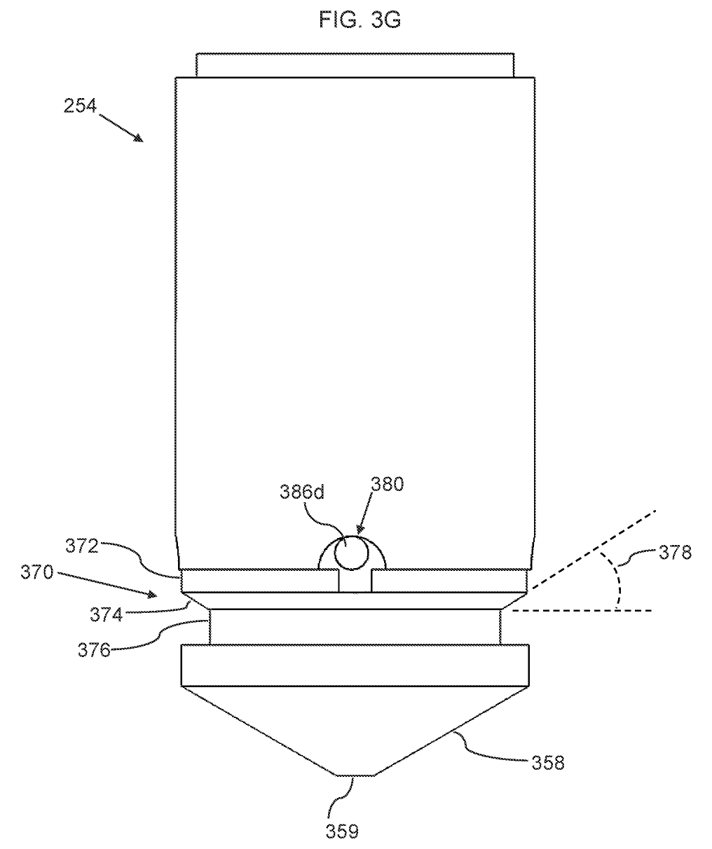

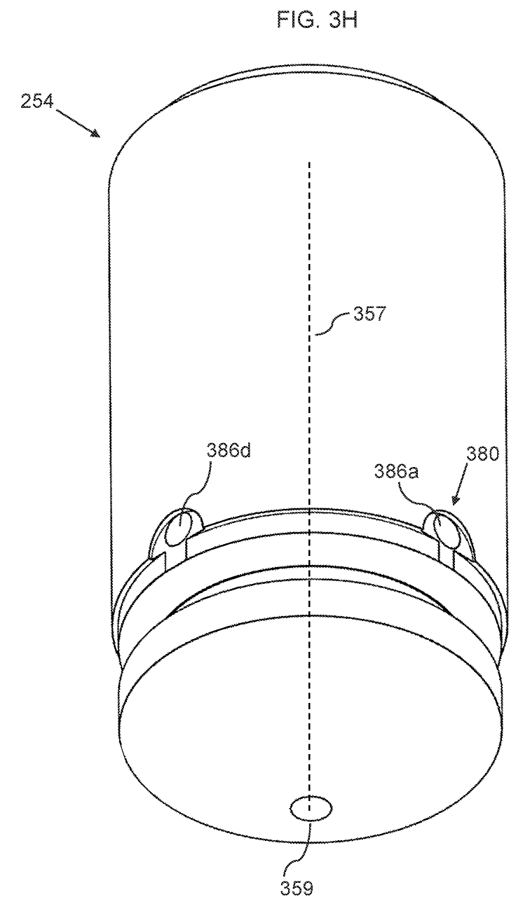

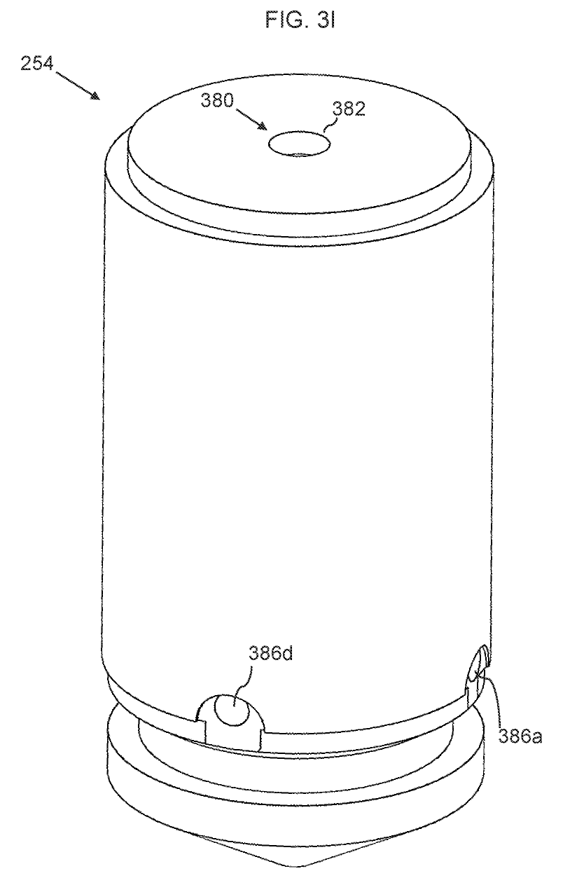

i. control the linear actuator 230 to control an altitudinal/vertical sliding movement 347 of the actuator hammer 236, as shown FIG. 3B, such that the ejection controller 610 controls ejection of resin droplets 122 from the liquid ejection unit 140; all connected via

e) A data bus 820.

In further related embodiments, the disclosure of the braille printing system 400 and the engraving machine 280 shall be understood to include the use of various well-known mechanisms for longitudinal and lateral (and optionally altitudinal) movement of the braille printing device 100. Thus, the assembly body 442 or the engraving machine 280 shall be understood to include various related designs in use for additive and robotic manufacturing, including robotic arms, controllable “gooseneck” arms, and other designs permitting lateral and longitudinal positional adjustment and optionally height adjustment over a printing surface.

In related embodiments, advantages of the braille printing device 100, include:

a) When mounted to a moveable portion 282 of an engraving machine 280, use of the braille printing device 100 only requires longitudinal and lateral movement capability of the moveable portion 282 of the engraving machine 280;

b) bypasses the need to drill hole in the signs surface;

c) uses far less steps to generate braille dots, as compared to conventional methods and systems;

d) faster and simpler to operate, as compared to conventional methods and systems; and

e) produces more durable Braille dots.

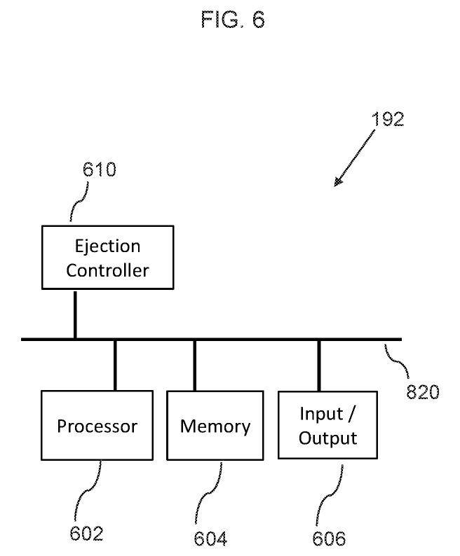

FIGS. 1C, 4, 5, and 6 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1C, 4, 5, and 6 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

It shall be understood that the above-mentioned components of the control unit 192 are to be interpreted in the most general manner.

For example, the processor 602 can include a single physical microprocessor or microcontroller, a cluster of processors, a datacenter or a cluster of datacenters, a computing cloud service, and the like.

In a further example, the non-transitory memory 604 can include various forms of non-transitory storage media, including random access memory and other forms of dynamic storage, and hard disks, hard disk clusters, cloud storage services, and other forms of long-term storage. Similarly, the input/output 606 can include a plurality of well-known input/output devices, such as screens, keyboards, pointing devices, motion trackers, communication ports, and so forth.

Furthermore, it shall be understood that the control unit 192 can include a number of other components that are well known in the art of general computer devices, and therefore shall not be further described herein. This can include system access to common functions and hardware, such as for example via operating system layers such as WINDOWS™, LINUX™, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the control unit 192 can communicate with external devices, such as an app executing on a smartphone, over a network, which can include the general Internet, a Wide Area Network or a Local Area Network, or another form of communication network, transmitted on wired or wireless connections. Wireless networks can for example include Ethernet, Wi-Fi, BLUETOOTH™, ZIGBEE™, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

Here has thus been described a multitude of embodiments of the braille printing device 100, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. A braille printing device, comprising:
(a) a device body, which is configured to be detachably connected to a moveable portion of an engraving machine, such that the device body is configured to be longitudinally and laterally moveable by a corresponding movement of the moveable portion of the engraving machine; (b) a linear actuator, which comprises:
an actuator body, which is connected to the device body; and
an actuator hammer, which is configured to be vertically slidable, relative to the actuator body; and
(c) a liquid ejection unit, comprising:
a liquid container, which comprises a container interior with an upper opening, such that the container interior is configured to contain a liquid resin;
a piston assembly, which penetrates into the container interior via the upper opening, such that a lower part of the piston assembly seals walls of the container interior, and such that downward pressure on an upper part of the piston assembly pressurizes the liquid resin in the container interior; and
an ejection aperture, which is in fluid contact with the liquid container;
such that when the actuator hammer strikes the upper part of the piston assembly, this causes the lower part of the piston assembly to impact with the liquid resin, such that the lower part of the piston assembly causes a shockwave to travel through the liquid resin, such that the shockwave pushes out an ejected resin droplet from the ejection aperture, such that the ejected resin droplet is ejected downwards from the ejection aperture;
such that the ejected resin droplet impacts with a surface of a printing substrate below the ejection aperture, such that the ejected resin droplet forms a braille dot on the surface of the printing substrate.

2. The braille printing device of claim 1, further comprising:
a tapering tube, which is hollow, such that an upper end of the tapering tube is in fluid connection with the liquid container, wherein a lower end of the tapering tube comprises the ejection aperture, wherein the tapering tube is configured with a downward diminishing interior diameter, such that the downward diminishing interior diameter of the tapering tube increases a speed of the liquid resin, such that a surface tension of the liquid resin is overcome, to enable release of the ejected resin droplet.

3. The braille printing device of claim 2, wherein an interior of the tapering tube is configured with a conical shape.

4. The braille printing device of claim 2, further comprising:
a connection tube, which is hollow, such that an upper end of the connection tube is in fluid connection with the liquid container and a lower end of the connection tube is in fluid connection with the upper end of the tapering tube, such that the connection tube stabilizes the shockwave before the shockwave enters the tapering tube.

5. The braille printing device of claim 1, wherein the piston assembly further comprises:
a piston member, which is at least partially inserted into the liquid container.

6. The braille printing device of claim 5, wherein a lower end of the piston member is configured with a conical portion, such that at least a bounced portion of the shockwave will be directed outwards and downwards, such that the bounced portion of the shockwave bounces off inner sides of the liquid container, such that the shockwave is concentrated in a lower longitudinal center of the liquid container.

7. The braille printing device of claim 6, wherein a lower center of the lower end of the piston member is further configured with a flat circular portion that is connected around a lower end of the conical portion, such that the flat circular portion is perpendicular to an elongated central axis of the piston member, such that a central portion of the shockwave will be directed downwards, such that the bounced portion of the shockwave and the central portion of the shockwave merge in the lower longitudinal center of the liquid container.

8. The braille printing device of claim 5, wherein the piston assembly further comprises an o-ring, and wherein the piston member is further configured with a ring indentation, which encircles an outer surface of the piston member, such that the o-ring is mounted in the ring indentation, such that the o-ring is configured to prevent leakage of the liquid resin, wherein the ring indentation comprises:
(a) a tapered indentation, which tapers inward in a downward direction from the outer surface of the piston member above the ring indentation; and (b) a main ring portion, such that an upper end of the main ring portion is connected with a lower end of the tapered indentation;
such that the o-ring is pressed against the tapered indentation when the piston assembly is moving downward, such that the o-ring expands, whereby a sealing of the piston assembly is tightened; and
such that the o-ring is released from the tapered indentation when the piston assembly is moving upward, such that the o-ring expands, whereby a sealing of the piston assembly is released.

9. The braille printing device of claim 8, wherein the tapered indentation is a conical segment, which is configured with a uniform tapering angle in a range of 30 – 34 degrees.

10. The braille printing device of claim 9, wherein the uniform tapering angle is 32 degrees.

11. The braille printing device of claim 5, wherein the piston assembly further comprises an o-ring, and wherein the piston member is further configured with a ring indentation, which encircles an outer surface of the piston member, such that the o-ring is mounted in the ring indentation, such that the o-ring is configured to prevent leakage of the liquid resin;
wherein the piston member is further configured with a lubrication canal system, which projects into the piston member from an upper canal opening, wherein the lubrication canal system comprises:
(a) an upper central vertical canal, which projects into the piston member; and(b) at least one side canal, such that an inner end of the at least one side canal is connected to a lower end of the upper central vertical canal, and such that an outer end of the upper central vertical canal is in fluid contact with the ring indentation;
such that the lubrication canal system is configured to deliver a lubrication liquid from the upper canal opening to the ring indentation, to lubricate the o-ring.

12. The braille printing device of claim 11, wherein the at least one side canal comprises four side canals, which are uniformly positioned to project from the lower end of the upper central vertical canal to right, left, front, and rear sides of the piston member.

13. The braille printing device of claim 11, wherein the ring indentation comprises:
(a) a top ring portion, such that the outer end of the at least one side canal is in fluid contact with the top ring portion, such that the top ring portion enables a flow of the lubrication liquid around the top ring portion above the o-ring; (b) a tapered indentation, such that a lower end of the top ring portion is connected with an upper end of the tapered indentation which tapers inward in a downward direction from the outer surface of the piston member above the ring indentation; and (c) a main ring portion, such that an upper end of the main ring portion is connected with a lower end of the tapered indentation;
such that the o-ring will be pressed against the tapered indentation when the piston assembly is moving downward, such that the o-ring expands, whereby a sealing of the piston assembly is tightened; and
such that the o-ring will be released from the tapered indentation when the piston assembly is moving upward, such that the o-ring expands, whereby a sealing of the piston assembly is released.

14. The braille printing device of claim 1, further comprising:
a control unit, which is configured to control the liquid ejection unit.

15. The braille printing device of claim 14, wherein the control unit further comprises:
(a) a processor;(b) a non-transitory memory;(c) an input/output; and(d) an ejection controller, which is configured to control the linear actuator to control a vertical sliding movement of the actuator hammer, such that the ejection controller controls ejection of the ejected resin droplet from the liquid ejection unit; all connected via (e) a data bus.

16. The braille printing device of claim 1, wherein the liquid container further comprises:
the liquid resin;
wherein the liquid resin is an optically sensitive resin, which is configured to cure when exposed to ultraviolet light.

17. A braille printing device, comprising:
(a) a linear actuator, which comprises:
an actuator body; and
an actuator hammer, which is configured to be vertically slidable, relative to the actuator body; and
(b) a liquid ejection unit, comprising:
a liquid container, which comprises a container interior with an upper opening, such that the container interior is configured to contain a liquid resin;
a piston assembly, which penetrates into the container interior via the upper opening, such that a lower part of the piston assembly seals walls of the container interior, and such that downward pressure on an upper part of the piston assembly pressurizes the liquid resin in the container interior; and
an ejection aperture, which is in fluid contact with the liquid container;
such that when the actuator hammer strikes the upper part of the piston assembly, this causes the lower part of the piston assembly to impact with the liquid resin, such that the lower part of the piston assembly causes a shockwave to travel through the liquid resin, such that the shockwave pushes out an ejected resin droplet from the ejection aperture, such that the ejected resin droplet is ejected downwards from the ejection aperture;
such that the ejected resin droplet impacts with a surface of a printing substrate below the ejection aperture, such that the ejected resin droplet forms a braille dot on the surface of the printing substrate.

18. The braille printing device of claim 17, further comprising:
a tapering tube, which is hollow, such that an upper end of the tapering tube is in fluid connection with the liquid container, wherein a lower end of the tapering tube comprises the ejection aperture, wherein the tapering tube is configured with a downward diminishing interior diameter, such that the downward diminishing interior diameter of the tapering tube increases a speed of the liquid resin, such that a surface tension of the liquid resin is overcome, to enable release of the ejected resin droplet.

19. The braille printing device of claim 18, further comprising:
a connection tube, which is hollow, such that an upper end of the connection tube is in fluid connection with the liquid container and a lower end of the connection tube is in fluid connection with the upper end of the tapering tube, such that the connection tube stabilizes the shockwave before the shockwave enters the tapering tube.

20. The braille printing device of claim 17, wherein the piston assembly further comprises:
a piston member, which is at least partially inserted into the liquid container.

21. The braille printing device of claim 20, wherein a lower end of the piston member is configured with a conical portion, such that at least a bounced portion of the shockwave will be directed outwards and downwards, such that the bounced portion of the shockwave bounces off inner sides of the liquid container, such that the shockwave is concentrated in a lower longitudinal center of the liquid container.

22. The braille printing device of claim 21, wherein a lower center of the lower end of the piston member is further configured with a flat portion that is connected around a lower end of the conical portion, such that a central portion of the shockwave will be directed downwards, such that the bounced portion of the shockwave and the central portion of the shockwave merge in the lower longitudinal center of the liquid container.

23. The braille printing device of claim 20, wherein the piston assembly further comprises an o-ring, and wherein the piston member is further configured with a ring indentation, which encircles an outer surface of the piston member, such that the o-ring is mounted in the ring indentation, such that the o-ring is configured to prevent leakage of the liquid resin, wherein the ring indentation comprises:
(a) a tapered indentation, which tapers inward in a downward direction from the outer surface of the piston member above the ring indentation; and (b) a main ring portion, such that an upper end of the main ring portion is connected with a lower end of the tapered indentation;
such that the o-ring is pressed against the tapered indentation when the piston assembly is moving downward, such that the o-ring expands, whereby a sealing of the piston assembly is tightened; and
such that the o-ring is released from the tapered indentation when the piston assembly is moving upward, such that the o-ring expands, whereby a sealing of the piston assembly is released.

24. The braille printing device of claim 23, wherein the tapered indentation is a conical segment, which is configured with a uniform tapering angle in a range of 30 – 34 degrees.

25. The braille printing device of claim 20, wherein the piston assembly further comprises an o-ring, and wherein the piston member is further configured with a ring indentation, which encircles an outer surface of the piston member, such that the o-ring is mounted in the ring indentation, such that the o-ring is configured to prevent leakage of the liquid resin;
wherein the piston member is further configured with a lubrication canal system, which projects into the piston member from an upper canal opening, wherein the lubrication canal system comprises:
(a) an upper central vertical canal, which projects into the piston member; and(b) at least one side canal, such that an inner end of the at least one side canal is connected to a lower end of the upper central vertical canal, and such that an outer end of the upper central vertical canal is in fluid contact with the ring indentation;
such that the lubrication canal system is configured to deliver a lubrication liquid from the upper canal opening to the ring indentation, to lubricate the o-ring.

26. The braille printing device of claim 25, wherein the at least one side canal comprises four side canals which are uniformly positioned to project from the lower end of the upper central vertical canal to right, left, front, and rear sides of the piston member.

27. The braille printing device of claim 25, wherein the ring indentation comprises:
(a) a top ring portion, such that the outer end of the at least one side canal is in fluid contact with the top ring portion, such that the top ring portion enables a flow of the lubrication liquid around the top ring portion above the o-ring; (b) a tapered indentation, such that a lower end of the top ring portion is connected with an upper end of the tapered indentation which tapers inward in a downward direction from the outer surface of the piston member above the ring indentation; and (c) a main ring portion, such that an upper end of the main ring portion is connected with a lower end of the tapered indentation;
such that the o-ring will be pressed against the tapered indentation when the piston assembly is moving downward, such that the o-ring expands, whereby a sealing of the piston assembly is tightened; and
such that the o-ring will be released from the tapered indentation when the piston assembly is moving upward, such that the o-ring expands, whereby a sealing of the piston assembly is released.
